(19) United States
(12) Patent Application Publication
(10) Pub. No.: US 2024/0151590 A1
(43) Pub. Date: May 9, 2024

(54) CHARGING STRUCTURE

(71) Applicant: SHENZHEN CHENBEI TECHNOLOGY CO., LTD., Shenzhen (CN)

(72) Inventors: XianFeng JIA, Shenzhen (CN); XiaoBin WANG, Shenzhen (CN)

(21) Appl. No.: 18/502,513

(22) Filed: Nov. 6, 2023

(30) Foreign Application Priority Data
Nov. 7, 2022 (CN) 202211384615.X

(51) Int. Cl. G01K 1/08

(52) U.S. Cl. CPC G01K 1/08; G01K 2207/02; G01K 2215/00

(57) ABSTRACT

A charging structure configured to charge a food thermometer is provided. The charging structure includes a housing, a first electrode component, a second electrode component, and an energy storage element. The housing includes a storage groove for storing the food thermometer. The first electrode component and the second electrode component are disposed on opposite ends of the storage groove, and the first electrode component and the second electrode component are configured to abut against a third electrode and a fourth electrode that are disposed on opposite ends of the food thermometer, respectively. The energy storage element is disposed inside the housing and is electrically connected to the first electrode component and the second electrode component.

### CROSS-REFERENCE TO RELATED APPLICATION

This application claims the priority of Chinese patent application No. 202211384615.X, filed on Nov. 7, 2022, the entirety of which is incorporated herein by reference.

### FIELD

The present disclosure generally relates to the field of temperature measuring component technology and, more particularly, relates to a charging structure.

### BACKGROUND

During food processing and cooking, such as when grilling and heating food, especially substantially thick food, it is often difficult for people to determine whether the inside of the food is fully cooked through visual observation. At present, the usual method is to insert a food thermometer into the food to measure the internal temperature and determine whether the food is cooked thoroughly.

After being used for a period of time, the food thermometer needs to be recharged. At present, most charging structures involve two spring-loaded contact pieces surrounding the food thermometer to install and charge the food thermometer. Such installation method has certain drawbacks. On the one hand, the presence of these contact pieces surrounding the food thermometer affects the overall appearance of the product, and on the other hand, the repeated use of these spring-loaded contact pieces will lead to a decrease in clamping force of the contact pieces, and in serious cases, will even result in the problem of inability to charge properly due to poor connection.

### SUMMARY

One aspect of the present disclosure provides a charging structure configured to charge a food thermometer. The charging structure includes a housing, a first electrode component, a second electrode component, and an energy storage element. The housing includes a storage groove for storing the food thermometer. The first electrode component and the second electrode component are disposed on opposite ends of the storage groove, and the first electrode component and the second electrode component are configured to abut against a third electrode and a fourth electrode that are disposed on opposite ends of the food thermometer, respectively. The energy storage element is disposed inside the housing and is electrically connected to the first electrode component and the second electrode component.

Another aspect of the present disclosure provides a food thermometer and a charging structure configured to charge the food thermometer. The charging structure includes a housing, a first electrode component, a second electrode component, and an energy storage element. The housing includes a storage groove for storing the food thermometer. The first electrode component and the second electrode component are disposed on opposite ends of the storage groove, and the first electrode component and the second electrode component are configured to abut against a third electrode and a fourth electrode that are disposed on opposite ends of the food thermometer, respectively. The energy storage element is disposed inside the housing and is electrically connected to the first electrode component and the second electrode component.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a three-dimensional schematic diagram of an exemplary temperature measuring component consistent with disclosed embodiments of the present disclosure;

FIG. 2 illustrates a three-dimensional schematic diagram of an exemplary charging structure consistent with disclosed embodiments of the present disclosure;

FIG. 3 illustrates a three-dimensional schematic diagram of an exemplary food thermometer consistent with disclosed embodiments of the present disclosure;

FIG. 4 illustrates a cross-sectional view of the food thermometer in FIG. 3 consistent with disclosed embodiments of the present disclosure;

FIG. 5 illustrates a cross-sectional view of the temperature measuring component in FIG. 1 consistent with disclosed embodiments of the present disclosure;

FIG. 6 illustrates a local zoom-in view of a region A in FIG. 5 consistent with disclosed embodiments of the present disclosure;

FIG. 7 illustrates a cross-sectional view of the charging structure in FIG. 2 consistent with disclosed embodiments of the present disclosure;

FIG. 8 illustrates a local zoom-in view of a region B in FIG. 7 consistent with disclosed embodiments of the present disclosure;

FIG. 9 illustrates a local zoom-in view of a region C in FIG. 7 consistent with disclosed embodiments of the present disclosure;

FIG. 10 illustrates a schematic diagram of an exemplary first electrode component in FIG. 4 consistent with disclosed embodiments of the present disclosure; and

FIG. 11 illustrates an exploded schematic diagram of the first electrode component in FIG. 10 consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Various modifications and changes can be made to the embodiments of the present disclosure without departing from the spirit or scope of the present disclosure, which is apparent to those skilled in the art. Therefore, the present disclosure is intended to cover modifications and changes falling within the scope of the corresponding claims (the technical solutions to be protected) and their equivalents. It should be noted that the embodiments provided by the present disclosure can be combined with each other without contradiction.

Similar reference numbers and letters represent similar terms in the following Figures, such that once an item is defined in one Figure, it does not need to be further discussed in subsequent Figures.

In the description of the present disclosure, it should be understood that terms indicating orientations or positional relationships, such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc., may be based on the orientations or positional relationships shown in the accompanying drawings. These terms may be used for the convenience of describing the present disclosure and simplifying the description, and may not indicate or imply that the devices or components referred to must have specific orientations, be constructed and operated in specific orientations. Therefore, such terms should not be interpreted as limitations of the present disclosure. Furthermore, terms such as “first” and “second” may be merely used for descriptive purposes and should not be interpreted as indicating relative importance or implying a specific quantity of indicated technical features. Therefore, features labeled as “first” or “second” may explicitly or implicitly include one or more of those features. In the description of the present disclosure, the terms “multiple” or “a plurality of” may mean two or more, unless otherwise explicitly specified.

In the description of the present disclosure, it should be clarified that unless specifically stated and defined otherwise, terms such as “install”, “connect”, and “joint” should be broadly interpreted. For example, the terms may refer to a fixed connection, a detachable connection, or an integral connection; may be a mechanical connection, an electrical connection, or a communicative connection; may be a direct connection, or an indirect connection through intermediary elements; and may represent interconnection between the two elements or interaction between the two elements. For the ordinary skilled in the art, the specific meanings of these terms in the context of the present disclosure may be understood based on specific circumstances.

In the present disclosure, unless specifically stated and defined otherwise, the term “above” or “below” with reference to the first feature relative to the second feature may include direct contact between the first and second features or indirect contact between them through additional features. Additionally, the first feature being “above”, “over”, and “on top” of the second feature may indicate the first feature is directly above or diagonally above the second feature, or may merely indicate that the first feature is at a higher horizontal level than the second feature. The first feature being “below”, “under”, and “beneath” the second feature may indicate the first feature is directly below or diagonally below the second feature, or may merely indicate that the first feature is at a lower horizontal level than the second feature.

The following disclosure provides numerous different embodiments or examples for implementing various structures of the present disclosure. To simplify the present disclosure, specific components and configurations of specific examples are described. However, these descriptions are merely provided for illustrative purposes and are not intended to limit the present disclosure. Additionally, references to specific numbers and/or letters may be repeated across different examples for the purpose of clarity and simplification, without implying relationships between various embodiments and/or configurations being discussed. Furthermore, specific examples of processes and materials are provided, but those skilled in the art may recognize the application of other processes and/or the use of other materials.

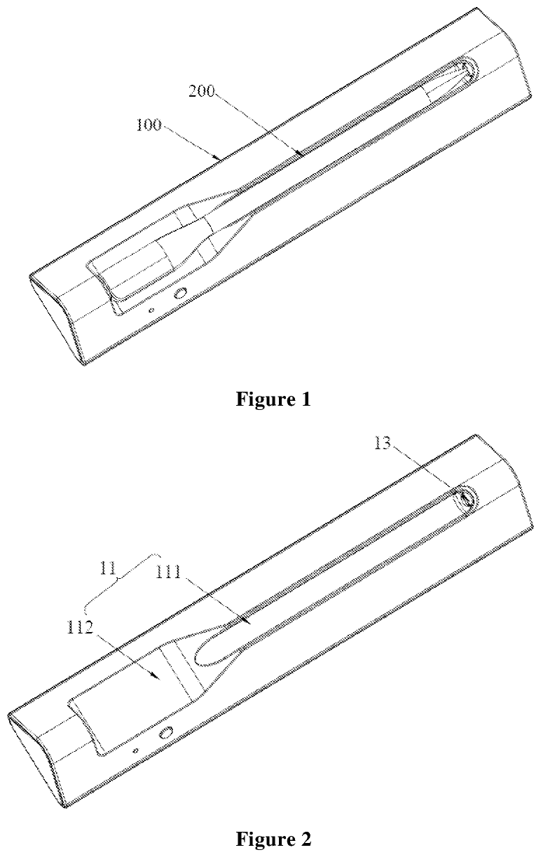

The present disclosure provides a charging structure. Referring to FIG. 1 and FIG. 2, the disclosed charging structure 100 may be configured to charge a food thermometer 200, to ensure the temperature measurement performance of the food thermometer 200.

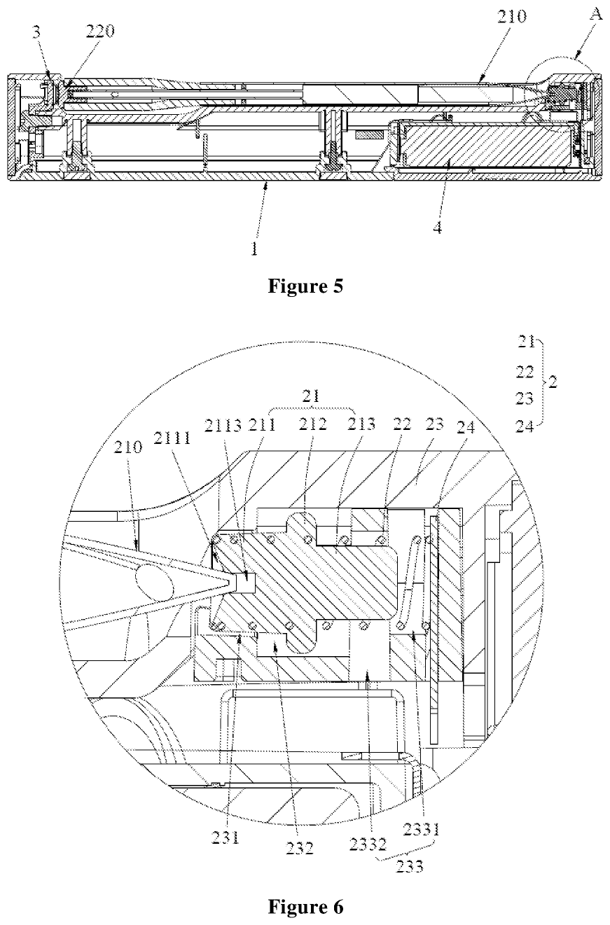

Referring to FIG. 5 and FIG. 6, the charging structure 100 may include a housing 1, a first electrode component 2, a second electrode component 3, and an energy storage element 4. The housing 1 may include a storage groove 11 for storing the food thermometer 200. The first electrode component 2 and the second electrode component 3 may be disposed on opposite ends of the storage groove 11. The first electrode component 2 and the second electrode component 3 may be configured to abut against a third electrode 210 and a fourth electrode 220 that are disposed on opposite ends of the food thermometer 200, respectively. In one embodiment, the first electrode component 2 may elastically abut against the third electrode 210, and/or the second electrode component 3 may elastically abut against the fourth electrode 220. The energy storage element 4 may be disposed inside the housing 1 and may be electrically connected to the first electrode component 2 and the second electrode component 3.

In one embodiment, the opposite ends of the food thermometer 200 may refer to the opposite ends of the food thermometer 200 along the length extension direction of the food thermometer 200. When the food thermometer 200 is stored in the storage groove 11, the length extension direction of the food thermometer 200 may be the same as the length extension direction of the storage groove 11. The opposite ends of the storage groove 11 may refer to the opposite ends of the storage groove 11 along the length extension direction of the storage groove 11. When the first electrode component 2 and the second electrode component 3 are disposed on opposite ends of the storage groove 11, the first electrode component 2 and the second electrode component 3 may abut against the third electrode 210 and the fourth electrode 220, respectively.

For the installation restriction of the food thermometer 200 on the charging structure 100, the food thermometer 200 may be first inserted into the storage groove 11 for storing. Then, the first electrode component 2 and the second electrode component 3 may be configured to abut against and restrict the movement of the third electrode 210 and the fourth electrode 220, respectively. Therefore, the food thermometer 200 may be capable of being restricted and secured along the length direction of the food thermometer 200, and the food thermometer 200 may be firmly installed on the charging structure 100.

In one embodiment, the first electrode component 2 may either elastically abut against the third electrode 210, or may be in a rigid contact with the third electrode 210. The second electrode component 3 may either elastically abut against the fourth electrode 220, or may be in a rigid contact with the fourth electrode 220. It should be noted that at least one of the group between the first electrode component 2 and the third electrode 210 and the group between the second electrode component 3 and the fourth electrode 220 may be elastic contact. For example, when the first electrode component 2 elastically abuts against the third electrode 210 and the first electrode component 2 is an elastic end, during installation, the third electrode 210 of the food thermometer 200 may be first placed in the storage groove 11 and the third electrode 210 may abut against the first electrode component 2. After being abutted against the third electrode 210, the first electrode component 2 may elastically move away from the second electrode component 3, to drive the food thermometer 200 to move away from the second electrode component 3. In view of this, the spacing between the food thermometer 200 and the second electrode component 3 may be substantially large enough to allow the fourth electrode 220 of the food thermometer 200 to be inserted into the storage groove 11 and make the fourth electrode 220 abut against the second electrode component 3.

When the third electrode 210 of the food thermometer 200 is electrically connected to the first electrode component 2, and the fourth electrode 220 is electrically connected to the second electrode component 3, because the energy storage element 4 is electrically connected to both the first electrode component 2 and the second electrode component 3, the food thermometer 200 may be charged via the energy storage element 4.

In the disclosed charging structure 100, the storage groove 11 may be disposed on the housing 1 to accommodate the food thermometer 200, and the first electrode component 2 and the second electrode component 3 disposed on opposite ends of the storage groove 11 may be electrically connected with the third electrode 210 and the fourth electrode 220 disposed on opposite ends of the food thermometer 200, respectively, to achieve the charging of the food thermometer 200 by the charging structure. In other words, during the charging process of the food thermometer 200, there will be no any other installation restriction structure on the outer peripheral surface of the food thermometer 200, and thus the food thermometer 200 and the charging structure 100 may have a neat and beautiful appearance.

Additionally, the first electrode component 2 may be elastically abut against the third electrode 210, and/or the second electrode component 3 may be elastically abut against the fourth electrode 220, such that the food thermometer 200 may be installed between the first electrode component 2 and the second electrode component 3 by elastic installation restriction at one end, and the food thermometer 200 may be easily inserted into the charging structure 100. Furthermore, the food thermometer 200 may be firmly installed on the charging structure 100 and may be prevented from displacement and detachment, ensuring a reliable electrical connection between the charging structure 100 and the food thermometer 200, such that the charging may be reliable.

In one embodiment, referring to FIG. 2, the storage groove 11 may be configured for peripheral position restriction of the food thermometer 200. In one embodiment, referring to FIG. 2, the storage groove 11 may partially enclose the food thermometer 200 along the circumference of the food thermometer 200, where the storage groove 11 may be an arc-shaped groove with an opening along the circumference of the food thermometer 200. In another embodiment, the storage groove 11 may fully enclose the food thermometer 200 along the circumference of the food thermometer 200. For example, the storage groove 11 may be a storage cavity that fully cover the food thermometer 200. Furthermore, the peripheral position restriction of the food thermometer 200 by the storage groove 11 may refer to that the tube of the food thermometer 200 may have a cylindrical shape, and the storage groove 11 may enclose the food thermometer 200 along the circumference of the food thermometer 200. When the food thermometer 200 has any other shape, the peripheral position restriction of the food thermometer 200 by the storage groove 11 may refer to restricting at least two sides of the circumference of the food thermometer 200.

In one embodiment, referring to FIG. 4, the food thermometer 200 may include a tube, a handle 230, a temperature measuring circuit 240, a battery 250, and the fourth electrode 220. The tube may serve as the third electrode 210, and the third electrode may have a cylindrical shape and a tip. The handle 230 may be mounted at one end of the third electrode 210 away from the tip. Both the third electrode 210 and the handle 230 may include a cavity, and both the temperature measuring circuit 240 and the battery 250 may be located in the cavity of the third electrode 210 and the handle 230. The third electrode 210 may be made of a conductive metal material and may be electrically connected to the negative pole of the battery 250. Therefore, the third electrode 210 may serve as the negative pole of the entire food thermometer 200. The fourth electrode 220 may be installed on one end of the handle 230 away from the third electrode 210, and may be electrically connected to the positive pole of the battery 250. Therefore, the fourth electrode 220 may serve as the positive pole of the entire food thermometer 200.

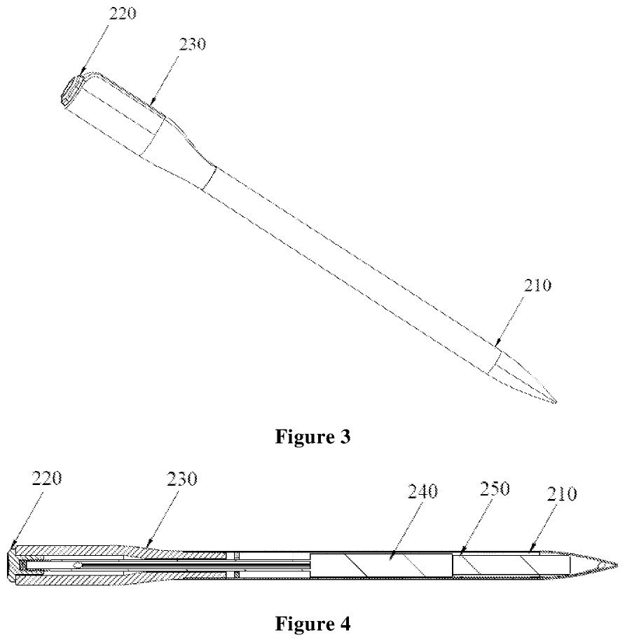

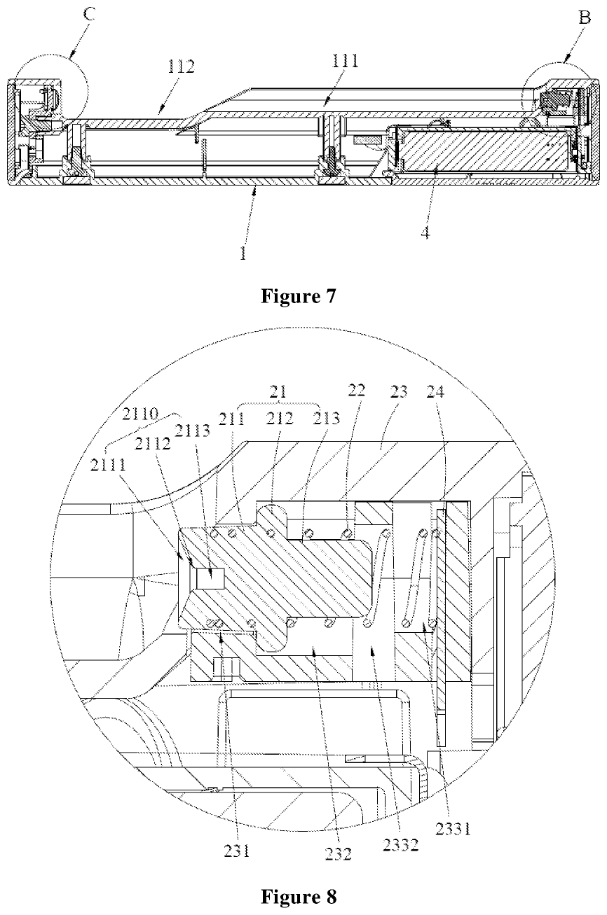

Referring to FIG. 2, FIG. 3, and FIG. 7, the third electrode 210 may have a cylindrical shape with a conical tip. The handle 230 may have an irregular shape corresponding to the structural design of the food thermometer 200. The storage groove 11 of the housing 1 may include a first storage portion 111 and a second storage portion 112. The first storage portion 111 may be configured to accommodate the third electrode 210, and the second storage portion 112 may be configured to accommodate the handle 230. The radial cross-section of the first storage portion 111 may be an open arc shape, and the first storage portion 111 may be configured to accommodate the third electrode 210 and may be configured for peripheral position restriction of the third electrode 210. The second storage portion 112 may be a gap formed on the surface of the housing 1 and located between the first storage portion 111 and the second electrode component 3, and the gap may be configured to accommodate the handle 230.

In one embodiment, referring to FIG. 5, the third electrode 210 may be a tube with a tip. The first electrode component 2 may elastically abut against the third electrode 210. When being abutted against the third electrode 210, the first electrode component 2 may elastically move away from the second electrode component 3, and may cause the food thermometer 200 to move away from the second electrode component 3. In one embodiment, because the third electrode 210 has a tip, to achieve position restriction of the tip of the third electrode 210, the third electrode 210 may not directly abut against the first electrode component 2 to avoid damaging the tip. Moreover, a certain insertion length between the tip and the first electrode component 2 may be required to ensure a firm abutment. Therefore, the third electrode 210 and the first electrode component 2 may often need to be first installed, and an elastic abutment may be designed between the third electrode 210 and the first electrode component 2.

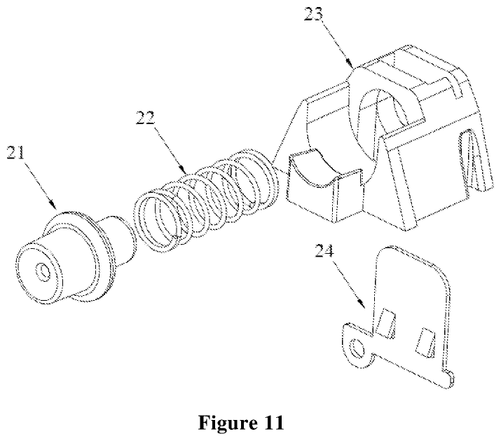

In one embodiment, referring to FIG. 6 and FIGS. 8-11, the first electrode component 2 may include a first electrode 21 and a first resilient element 22. The first resilient element 22 may be disposed between the first electrode 21 and the housing 1. In one embodiment, the disposure of the first resilient element 22 may allow for elastic abutment between the first electrode 21 and the third electrode 210, which may facilitate the abutment installation of the opposite ends of the food thermometer 200.

The first resilient element 22 may be made of a conductive metal material, and thus the first electrode 21 may be electrically connected to the energy storage element 4 through the first resilient element 22. In certain embodiments, the first resilient element 22 may be made of a non-conductive material, and in view of this, the first electrode 21 may be directly electrically connected to the energy storage element 4 or may be connected to the energy storage element 4 via a wire or a flexible circuit board.

In one embodiment, referring to FIG. 6 and FIGS. 8-10, the first electrode 21 may include a first limiting groove 2110. The first limiting groove 2110 may be configured to form an insertion position limitation with the third electrode 210. In one embodiment, the first limiting groove 2110 on the first electrode 21 may achieve the restriction for the third electrode 210, and at the same time, may form electrical connection with the third electrode 210.

In one embodiment, referring to FIG. 6 and FIG. 8, the first limiting groove 2110 may include an insertion portion 2111 and a guiding portion 2113. The guiding portion 2113 may have a conical shape, and a cone angle of the guiding portion may be greater than a cone angle of the third electrode 210. The center of the guiding portion 2113 may be configured to accommodate the tip of the third electrode 210. The guiding portion 2113 may have the conical shape, and the cone angle of the guiding portion 2113 may be greater than the cone angle of the third electrode 210, which may facilitate the insertion of the third electrode 210 into the insertion portion 2111.

In another embodiment, referring to FIG. 6 and FIG. 8, the center of the guiding portion 2113 may include the recessed insertion portion 2111, and the insertion portion 2111 may have a cylindrical shape. An inner diameter of the insertion portion 2111 may be greater than a minimum outer diameter of the third electrode 210, and the insertion portion 2111 may be configured to accommodate the tip of the third electrode 210. The insertion portion 2111 may have a cylindrical shape, and an inner diameter of the insertion portion 2111 may be greater than the minimum outer diameter of the third electrode 210, which may enable at least a portion of the third electrode 210 to be inserted into the insertion portion 2111, and may prevent the third electrode 210 from slipping out of the first limiting groove 2110.

In one embodiment, referring to FIG. 6 and FIG. 8, the first limiting groove 2110 may further include a transition portion 2112. The transition portion 2112 may be connected between the guiding portion 2113 and the insertion portion 2111. The transition portion 2112 may have a curved shape and may be configured to abut against the third electrode 210. In one embodiment, the insertion portion 2111 may have a cylindrical shape, and the inner diameter of the insertion portion 2111 may be greater than the minimum outer diameter of the third electrode 210. Therefore, the outer sidewall of the third electrode 210 may not tightly abut against the inner sidewall of the insertion portion 2111, and merely the transition portion 2112 between the guiding portion 2113 and the insertion portion 2111 may abut against the third electrode 210. In view of this, the abutment friction between the insertion portion 2111 and the third electrode 210 may be reduced, which may minimize potential damage to the third electrode 210. Additionally, the transition portion 2112 may have a curved shape, which may ensure a smooth and non-damaging abutment between the transition portion 2112 and the third electrode 210, and may not cause damage to the third electrode 210.

The length and inner diameter of the insertion portion 2111 may be determined based on the elastic properties of the first resilient element 22 and the cone angle of the third electrode 210, as long as at least a portion of the third electrode 210 is capable of being inserted into the insertion portion 2111 without slipping out from the insertion portion 2111.

It should be noted that in certain embodiments, the first limiting groove 2110 may have an overall conical shape, and the cone angle of the first limiting groove 2110 may match the cone angle of the third electrode 210, which may enable the third electrode 210 to fit snugly into the first limiting groove 2110.

In one embodiment, referring to FIG. 6, FIG. 8 and FIGS. 10-11, the charging structure 100 may further include a mounting seat 23. The mounting seat 23 may be configured to limit the sliding direction and travel distance of the first electrode 21, which may ensure that the direction of interaction between the first electrode 21 and the third electrode 210 may be parallel, and may not cause damage to each other. On the other hand, such design may reduce the need for complex structural features on the housing 1, which may reduce the manufacturing challenge of the housing 1. It should be understood that in certain embodiments, the charging structure 100 may not include the mounting seat 23, and the first electrode 21 may be slidably mounted on the housing 1. The housing 1 may guide the sliding motion of the first electrode 21, which may not be limited by the present disclosure.

The mounting seat 23 may be installed within the housing 1, and the first electrode 21 may be slidably mounted on the mounting seat 23. The first resilient element 22 may be compressed and disposed between the first electrode 21 and the mounting seat 23. The mounting seat 23 may be configured to guide the sliding motion and limit the travel distance of the first electrode 21.

Referring to FIG. 6, when the third electrode 210 is not inserted into the first electrode 21, the first resilient element 22 may be in a state of free extension. When the third electrode 210 is inserted into the first electrode 21, the third electrode 210 may exert pressure on the first electrode 21, which may cause the first electrode 21 to slide away from the second electrode component 3 on the mounting seat 23 and to compress the first resilient element 22. When the third electrode 210 is removed, the first electrode 21 may slide back under the influence of the elastic force of the first resilient element 22. In view of this, the mounting seat 23 may limit the reset motion of the first electrode 21, to prevent the first electrode 21 from sliding and disengaging from the mounting seat 23 under the influence of the first resilient element 22. Additionally, when the food thermometer 200 is pressed against the first electrode 21 in the direction away from the second electrode component 3, the first electrode 21 may require to slide in the direction away from the second electrode component 3. Otherwise, the first electrode 21 may damage the tip of the third electrode 210. Through the disposure of the mounting seat 23, the sliding motion of the first electrode 21 may be guided, which may ensure that the direction of interaction between the first electrode 21 and the third electrode 210 may be parallel and may not cause damage to each other.

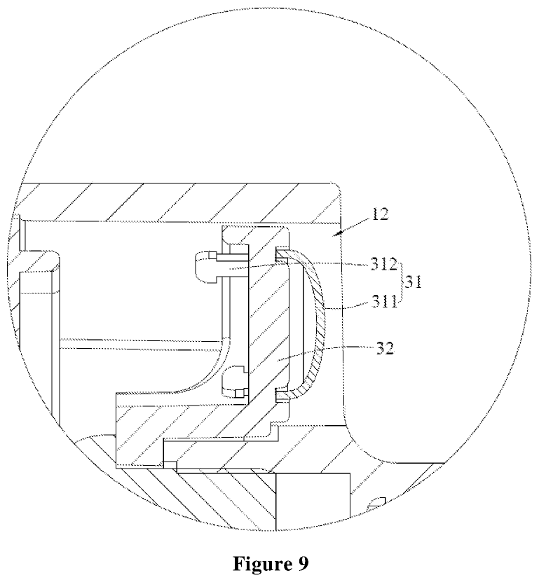

In one embodiment, referring to FIG. 6 and FIG. 9, the first electrode 21 may include an insertion segment 211 and a limiting segment 212. The insertion segment 211 may be configured for plug-in-insertion with the third electrode 210. In one embodiment, the first limiting groove 2110 may be formed on the insertion segment 211, and the limiting segment 212 may be connected to the insertion segment 211 in a stepped configuration. A first mating groove 231 and a second mating groove 232 that are interconnected with each other may be formed on the mounting seat 23. The inner surface of the first mating groove 231 and the outer surface of the insertion segment 211 may be at least partially matched along the circumferential direction, and the inner surface of the second mating groove 232 and the outer surface of the limiting segment 212 may be at least partially matched along the circumferential direction. The sliding of the limiting segment 212 may be stopped by the opposite inner walls of the second mating groove 232.

In one embodiment, the inner surface of the first mating groove 231 being at least partially matched with the outer surface of the insertion segment 211 along the circumferential direction may refer to that the inner surface of the first mating groove 231 may fully match the outer surface of the insertion segment 211 along the circumferential direction. For example, the first mating groove 231 may be a cylindrical groove, and the insertion segment 211 may be a cylindrical body. When the insertion segment 211 is inserted into the first mating groove 231, the first mating groove 231 may fully restrict the circumferential sliding of the insertion segment 211, thereby achieving guidance of the insertion segment 211.

In another embodiment, the inner surface of the first mating groove 231 may partially match the outer surface of the insertion segment 211 along the circumferential direction. The first mating groove 231 may be a semi-circular groove, and the insertion segment 211 may be a cylindrical body. When the insertion segment 211 is inserted into the first mating groove 231, the first mating groove 231 may still restrict the circumferential sliding of the insertion segment 211, thereby achieving guidance of the insertion segment 211.

Similarly, the inner surface of the second mating groove 232 being at least partially matched with the outer surface of the limiting segment 212 along the circumferential direction may refer to that the inner surface of the second mating groove 232 may fully match the outer surface of the limiting segment 212 along the circumferential direction. For example, the second mating groove 232 may be a cylindrical groove, and the limiting segment 212 may be a cylindrical body. When the limiting segment 212 is inserted into the second mating groove 232, the second mating groove 232 may fully restrict the circumferential sliding of the limiting segment 212, thereby achieving guidance of the limiting segment 212.

In another embodiment, the inner surface of the second mating groove 232 may be partially matched with the outer surface of the limiting segment 212 along the circumferential direction. For example, the second mating groove 232 may be a semi-circular groove, and the limiting segment 212 may be a cylindrical body. When the limiting segment 212 is inserted into the second mating groove 232, the second mating groove 232 may still restrict the circumferential sliding of the limiting segment 212, thereby achieving guidance of the limiting segment 212.

Additionally, the sliding of the limiting segment 212 may be stopped between the opposite inner walls of the second mating groove 232 along the length extension direction of the storage groove 11, such that the sliding travel distance of the limiting segment 212 may be limited.

In one embodiment, referring to FIG. 6 and FIG. 8, the first electrode component 21 may further include an installation segment 213. An outer diameter of the installation segment 213 may be smaller than an outer diameter of the limiting segment 212. The first resilient element 22 may be a cylindrical spring, where one end of the cylindrical spring may be sleeved on the installation segment 213, and the other end of the cylindrical spring may be fixed to the mounting seat 23. When the cylindrical spring expands and contracts, a portion of the cylindrical spring may always remain sleeved on the installation segment 213, which may allow the installation segment 213 to guide the expansion and contraction of the cylindrical spring and make a linear expansion and contraction of the cylindrical spring.

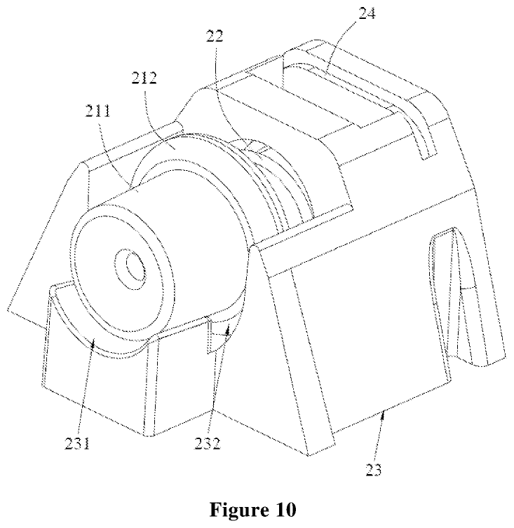

Referring to FIG. 10, in one embodiment, the first electrode 21 may be a rotary body, which may be compatible with the rotary body structure of the third electrode 210, facilitating plug-in-insertion between the third electrode 210 and the first electrode 21.

Referring to FIG. 6 and FIG. 8, a third mating groove 233 may be mounted on the mounting seat 23. The mounting seat 23 may be configured to accommodate and limit the installation segment 213 and the cylindrical spring. The inner diameter of the third mating groove 233 may be compatible with the outer diameter of the cylindrical spring. The third mating groove 233 may include a first mating segment 2331 and a second mating segment 2332 that are interconnected with each other. The first mating segment 2331 may be connected between the second mating groove 232 and the second mating segment 2332. To facilitate the installation of the limiting segment 212, the upper part of the first mating groove 231, the upper part of the second mating groove 232, and the upper part of the second mating segment 2332 may be designed to have an open semi-circular shape or a shape smaller than a semi-circular shape. The lower part of the first mating segment 2331 may be designed to have an open arc shape. In view of this, the first mating segment 2331 may provide upper and lower limits for the installation segment 213 of the first electrode 21, which may prevent the installation segment 213 from disengaging from the first mating segment 2331 and prevent the first electrode 21 from disengaging from the mounting seat 23.

In one embodiment, referring to FIG. 6 and FIG. 8, an electrode connection plate 24 may be mounted on the mounting seat 23. The first resilient element 22 may be compressed and disposed between the first electrode 21 and the electrode connection plate 24. The electrode connection plate 24 may be connected to the energy storage element 4. In one embodiment, through disposing the electrode connection plate 24 on the mounting seat 23 and establishing an electrical connection between the first electrode 21 and the electrode connection plate 24 through the first resilient element 22, the electrical connection between the first electrode 21 and the energy storage element 4 may be achieved by soldering a wire or a flexible circuit board onto the electrode connection plate 24. Such arrangement may eliminate the need to directly connect the mobile first electrode 21 to the energy storage element 4 with a wire. In certain embodiments, the electrode connection plate 24 may not be provided, and the first electrode 21 may be directly connected to the energy storage element 4 with a wire, which may not be limited by the present disclosure.

Referring to FIG. 2, a through-groove 13 may be formed on the housing 1. The through-groove 13 may be connected with the storage groove 11, and the through-groove 13 may be connected with the interior of the housing 1. The housing 1 may be configured for mounting the first electrode component 2.

Referring to FIG. 5 and FIG. 9, the second electrode component 3 may include a second electrode 31. A mounting bracket 32 may be mounted on the housing 1. The second electrode 31 may be securely mounted on the housing 1 by the mounting bracket 32. The second electrode 31 may be designed as an electrode spring plate, and the second electrode 31 may elastically abut against the fourth electrode 220. In one embodiment, because the fourth electrode 220 may not have a tip, the abutment area between the fourth electrode 220 and the second electrode 31 may be substantially large, such that the second electrode 31 may be configured as an electrode spring plate, and the second electrode 31 may elastically abut against the fourth electrode 220, which may allow a substantially tight elastic abutment and a reliable electrical connection. It should be understood that in certain embodiments, the second electrode component 3 may also be configured with a structure similar to the first electrode component 2. For example, the second electrode component 3 may include a second electrode 31 and a second elastic element. Additionally, the second electrode 31 may be designed to rigidly abut against the fourth electrode 220, which may not be limited by the present disclosure.

In one embodiment, referring to FIG. 9, a mounting groove 12 connected with the storage groove 11 may be formed on the housing 1. The second electrode component 3 may be mounted on the mounting groove 12. The mounting groove 12 may be configured for the insertion of the fourth electrode 220, which may abut against the second electrode component 3. In one embodiment, the fourth electrode 220 may elastically abut against the second electrode 31. During installation, the fourth electrode 220 may need to be inserted into the mounting groove 12 and abut against the second electrode 31. Therefore, the mounting groove 12 may restrict the movement of the fourth electrode 220, may prevent the fourth electrode 220 from coming out of the housing 1, and may prevent the fourth electrode 220 and the second electrode 31 from being separated from each other.

Referring to FIG. 9, the second electrode 31 may include an abutting portion 311 and three pins 312. The abutting portion 311 may be convex arc-shaped, and the three pins 312 may be connected to the periphery of the abutting portion 311. The three pins 312 may be respectively inserted into the mounting bracket 32. The fourth electrode 220 may include a concave arc-shaped groove. When the fourth electrode 220 abuts against the second electrode 31, the convex surface of the abutting portion 311 may match the concave groove.

In another embodiment, the first electrode component 2 may be any other type. For example, the first electrode component 2 may include a limiting element and the first electrode 21. The limiting element may be made of a soft rubber material, and may be elastic. A fourth limiting groove for the insertion and limiting the movement of the third electrode 210 may be formed on the limiting element. The first electrode 21 may be a spring pin. One end of the first electrode 21 may be placed in the fourth limiting groove and may be used to abut against the third electrode 210, and the other end of the first electrode 21 may be electrically connected to the energy storage element 4. When the third electrode 210 is inserted into the fourth limiting groove of the limiting element, because the limiting element is elastic and is capable of being compressed, the third electrode 210 may be capable of abutting against one end of the first electrode 21. At the same time, to prevent any collision between the first electrode 21 and the third electrode 210, the first electrode 21 may be configured as an elastic spring pin.

In certain embodiments, the first electrode component 2 may merely include the first electrode 21, and the first electrode 21 may be elastic. When the third electrode 210 is inserted into the first electrode 21, the first electrode 21 may be compressed and deformed to drive the third electrode 210 to move in the direction away from the second electrode component 3.

The present disclosure also provides a temperature measuring component. The temperature measuring component may include the food thermometer 200 and the above-disclosed charging structure 100. The charging structure 100 may be configured to charge the food thermometer 200.

In the descriptions of the present disclosure, terms such as “an embodiment”, “certain embodiments”, “exemplary embodiment”, “example”, “specific example”, or “certain example” may refer to specific features, structures, materials, or characteristics described in conjunction with the described embodiments or examples, which are encompassed by at least one embodiment or example of the present disclosure. In the present disclosure, the indicative expressions may not necessarily refer to the same embodiment or example. Moreover, the described specific features, structures, materials, or characteristics may be combined in suitable ways in one or more embodiments or examples.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments illustrated herein but is to be accorded the widest scope consistent with the principles and novel features disclosed herein.

What is claimed is:

1. A charging structure configured to charge a food thermometer, comprising:
a housing, a first electrode component, a second electrode component, and an energy storage element, wherein:
the housing includes a storage groove for storing the food thermometer,
the first electrode component and the second electrode component are disposed on opposite ends of the storage groove, and the first electrode component and the second electrode component are configured to abut against a third electrode and a fourth electrode that are disposed on opposite ends of the food thermometer, respectively, and
the energy storage element is disposed inside the housing and is electrically connected to the first electrode component and the second electrode component.

2. The charging structure according to claim 1, wherein:
the first electrode component elastically abuts against the third electrode, and/or the second electrode component elastically abuts against the fourth electrode.

3. The charging structure according to claim 1, wherein:
the food thermometer includes a tube, and the third electrode includes the tube with a tip, and
when being abutted against the third electrode, the first electrode component moves elastically away from the second electrode component.

4. The charging structure according to claim 1, wherein:
the first electrode component includes a first electrode and a first resilient element, and the first resilient element is disposed between the first electrode and the housing.

5. The charging structure according to claim 1, wherein:
the first electrode includes a first limiting groove configured to form an insertion position limitation with the third electrode.

6. The charging structure according to claim 5, wherein:
the first limiting groove includes a guiding portion with a conical shape.

7. The charging structure according to claim 6, wherein:
a cone angle of the guiding portion is greater than a cone angle of the third electrode.

8. The charging structure according to claim 6, wherein:
a center of the guiding portion is configured to accommodate the tip of the third electrode.

9. The charging structure according to claim 5, wherein:
the center of the guiding portion includes a recessed insertion portion with a cylindrical shape, wherein an inner diameter of the insertion portion is greater than a minimum outer diameter of the third electrode, and the insertion portion is configured to accommodate the tip of the third electrode.

10. The charging structure according to claim 1, wherein:
the housing includes a mounting seat, and the mounting seat is configured to limit a sliding direction and a travel distance of the first electrode.

11. The charging structure according to claim 10, wherein:
the first electrode includes an insertion segment and a limiting segment, wherein the insertion segment is configured for plug-in-insertion with the third electrode, and the limiting segment is connected with the insertion segment in a stepped configuration.

12. The charging structure according to claim 10, wherein:
a first mating groove and a second mating groove that are interconnected with each other are formed on the mounting seat, wherein an inner surface of the first mating groove and an outer surface of the insertion segment are at least partially matched along a circumferential direction, and an inner surface of the second mating groove and an outer surface of the limiting segment are at least partially matched along the circumferential direction.

13. The charging structure according to claim 10, wherein:
the sliding of the limiting segment is stopped by opposite inner walls of the second mating groove.

14. The charging structure according to claim 11, wherein:
the first electrode further includes an installation segment, wherein an outer diameter of the installation segment is smaller than an outer diameter of the limiting segment; and
the first resilient element is a cylindrical spring, wherein an end of the cylindrical spring is sleeved on the installation segment, and another end of the cylindrical spring is fixed to the mounting seat.

15. The charging structure according to claim 7, wherein:
an electrode connection plate is mounted on the mounting seat, wherein the first resilient element is disposed between the first electrode and the electrode connection plate, and the electrode connection plate is connected to the energy storage element.

16. The charging structure according to claim 1, wherein:
a mounting groove connected with the storage groove is formed on the housing, wherein the mounting groove is configured for inserting the fourth electrode to abut against the second electrode component.

17. The charging structure according to claim 1, wherein:
the storage groove includes a first storage portion and a second storage portion, wherein the first storage portion has an arc shape and is configured to accommodate the tube of the food thermometer and limit the food thermometer circumferentially, and the second storage portion is configured to accommodate a handle of the food thermometer.

18. A food temperature monitoring system, comprising:
a food thermometer and a charging structure configured to charge the food thermometer, the charging structure including:
a housing, a first electrode component, a second electrode component, and an energy storage element, wherein:
the housing includes a storage groove for storing the food thermometer,
the first electrode component and the second electrode component are disposed on opposite ends of the storage groove, and the first electrode component and the second electrode component are configured to abut against a third electrode and a fourth electrode that are disposed on opposite ends of the food thermometer, respectively, and
the energy storage element is disposed inside the housing and is electrically connected to the first electrode component and the second electrode component.

19. The food temperature monitoring system to claim 18, wherein:
the first electrode component elastically abuts against the third electrode, and/or the second electrode component elastically abuts against the fourth electrode.
